(19) United States
(12) Patent Application Publication
(10) Pub. No.: US 2013/0260784 A1
(43) Pub. Date: Oct. 3, 2013

(54) PERSONAL ELECTRONIC DEVICE LOCATOR

(71) Applicant: Christopher J. Lutz, Sudbury, MA (US)

(72) Inventor: Christopher J. Lutz, Sudbury, MA (US)

(21) Appl. No.: 13/434,239

(22) Filed: Mar. 29, 2012

(51) Int. Cl. H04W 64/00; H04M 1/00

(52) U.S. Cl. 455/456.1; 455/550.1

(57) ABSTRACT

A cellphone locator for finding a misplaced or lost cellphone or other personal electronic device emits an audible signal or alert when the cellphone has been stationary longer than a period of time typical for normal use. Location is sensed from a GPS, accelerometer or similar locating capability to indicate if the cellphone has remained stationary and unmoved for a predetermined time interval, as when a cellphone cannot be found by the user. Upon an elapsed interval of stationary usage, a beep or buzzing sound independent of a silent mode setting of the cellphone is initiated. The independent audible signal identifies the location even when the user has disabled a ringer function on the cellphone that would prevent locating the cellphone via an incoming call for identifying the location.

### BACKGROUND

As cellphone popularity increases, conventional wired telephones, and particularly the availability of public phones, suffer a corresponding decrease. Accordingly, cellphone users become increasingly younger as parents become concerned with modes of emergency contact and as cellphone providers offer basic services at lower cost due in part to a larger user base. The conventional wisdom of “carry a dime” for emergency phone calls has become obsolete not only in monetary terms, but also in applicability as public phones become increasingly sparse.

The cellphone population, therefore, continually expands down the age ranks as cellphone usage become feasible for younger and/or less affluent users. Expansion of the cellphone population to all members of the family results in a greater number of cellphone users overall. Further, cellphone functionality is continually integrated with other capabilities such as Internet browsers, schedulers (e.g. Outlook®, literature downloads (e.g. Kindle®), GPS capabilities, and other similar functions formerly reserved to larger laptops and stationary PCs, and thus results in an ever increasing number of personal electronic device units in use.

### SUMMARY

A cellphone locator for finding a misplaced or lost cellphone or other personal electronic device emits an audible signal or alert when the cellphone has been stationary longer than a period of time typical for normal use. Location is sensed from a GPS, accelerometer or similar signal to indicate if the cellphone has remained stationary and unmoved for a predetermined time interval, as when a cellphone cannot be found by the user. Upon an elapsed interval of stationary usage, a beep or buzzing sound independent of a silent mode setting of the cellphone is initiated. The independent audible signal identifies the location even when the user has disabled a ringer function on the cellphone that would prevent locating the cellphone via an incoming call for identifying the location.

In the configurations disclosed herein, in a wireless device environment supporting a plurality of personal electronic devices (PED), a cellphone or other PED employs a locator for a personal electronic device that receives a locator activation signal for initiating an audible alert for alerting proximate users as to the presence and location of the personal electronic device. The audible alert is independent from volume or ringer settings on the personal electronic device such that the audible alert is unaffected by a silent mode setting, and the PED renders the audible alert via an annunciator on the personal electronic device regardless of the silent mode setting.

As public phones become increasingly unavailable, cellphone users are increasingly more common among younger users. It is not uncommon for elementary school age children to carry a cellphone. The old adage of “carrying a dime” with you to make a call from a public phone is becoming obsolete, not only due to the cost of a call, but simply for the unavailability of the traditional public payphone. As a result, cellphone usage has infiltrated ranks of elementary school children, sometimes with cellphones that are enabled to only call certain recipients (parents, for example). However, many schools require that cellphones remain either powered off or silent so that classroom decorum is not compromised by sporadic and possibly unnecessary ring signals.

However, this same group of younger users is also among the most likely to misplace or “lose” a cellphone. Conventional approaches to finding a lost cellphone include calling the number from another phone, however, when the phone is silenced or powered off, no ringing signal can be heard. For example, a typical school age student puts their cellphone in silent mode by turning the ringer setting to “vibrate” just after exiting the morning school bus, as the schools typically prohibit cellphone ringing during school hours. Typically, the student reverts the cellphone to normal ringer mode when boarding the afternoon bus, however on a particular day forgets. Subsequently, after arrival at home, the student tosses the cellphone on a table, however it is thrown forcefully and, unbeknownst to the student, slides off the far end between the wall and the table. Sometime later, the student returns to retrieve their phone, but cannot locate it because it is out of sight on the floor behind the table (or chair, or bookcase, etc.). The student dials the number of the cellphone from the house wired line, however the cellphone remains in silent mode and the vibration does not result in an audible tone that can be heard by the user to assist in locating the cellphone.

Configurations herein are based, in part, on the observation that a popular manner of finding a lost cellphone is to call the cellphone from another phone so that the ringtone of the lost cellphone will identify the location, thus allowing a user to “home in” on the sound and find the cellphone. However, cellphones often employ a mute or silence feature to disable an audible ringtone and instead provide a “vibrating” ring that is felt or otherwise perceived, rather than heard, such as from placement in a pocket close to the body of the user. Cellphone ringers often are disabled in contexts where audible ringers are inappropriate, such as schools, performance exhibitions, and meetings, for example.

Unfortunately, therefore, conventional approaches to finding lost cellphones through the “call my phone” approach suffer from the shortcoming that, once silenced, cellphones cannot be reenabled to revert back to a conventional ringtone. Configurations herein substantially overcome the shortcomings of lost and silenced phones by providing a locator activation signal for overriding the silent mode setting and emitting an audible alert signal for alerting proximate users as to the location of the lost cellphone after a predetermined period of motionlessness during which the cellphone has remained stationary, such as when the cellphone falls behind a table or chair, under a car seat or between sofa cushions, for example. The audible alert, such as a ringtone or similar signal, activates after a stationery period longer than that occurring during normal usage, for example longer than an overnight period when a user may place the cellphone on a nightstand or counter. The audible alert overrides the silent ringer, or “vibrate” mode settings, and occurs before the battery becomes too weak to power such an audible signal.

In further detail, in a wireless device environment that supports a plurality of personal electronic devices, a method for locating a lost personal electronic device (i.e. cellphone) includes determining that the personal electronic device has been stationary for a predetermined time, such that the predetermined time has a duration indicative of misplacement of the device based on previous frequency of use, and emitting, based on the stationary determination, an audible alert for indicating the presence and location of the personal electronic device.

In a particular configurations, the method for finding a misplaced personal electronic device includes receiving, from a user input of the personal electronic device, a silent mode signal, such that the silent mode signal suppresses audible alerts for incoming messages, as when the user is in a noise-sensitive environment. The method determines, from a location sensing signal, that a location of the personal electronic device has remained unchanged for a predetermined interval, in which the location sensing signal is enabled by a default setting of the personal electronic device. The default setting is to avoid intentional user silencing which may tend to defeat the purpose of avoiding an unintentionally silenced device. The personal electronic device then emits, based on the unchanged location, an audible alert for alerting proximate users as to the presence and location of the personal electronic device, in which the audible alert is independent from volume or ringer settings on the personal electronic device such that the audible alert is unaffected by the silent mode setting.

Alternate configurations of the invention include a multiprogramming or multiprocessing computerized device such as a multiprocessor, controller or dedicated computing device in either a handheld, mobile, or desktop form or the like configured with software and/or circuitry (e.g., a processor as summarized above) to process any or all of the method operations disclosed herein as embodiments of the invention. Still other embodiments of the invention include software programs such as a Java Virtual Machine and/or an operating system that can operate alone or in conjunction with each other with a multiprocessing computerized device to perform the method embodiment steps and operations summarized above and disclosed in detail below. One such embodiment comprises a computer program product that has a non-transitory computer-readable storage medium including computer program logic encoded as instructions thereon that, when performed in a multiprocessing computerized device having a coupling of a memory and a processor, programs the processor to perform the operations disclosed herein as embodiments of the invention to carry out data access requests. Such arrangements of the invention are typically provided as software, code and/or other data (e.g., data structures) arranged or encoded on a computer readable medium such as an optical medium (e.g., CD-ROM), floppy or hard disk or other medium such as firmware or microcode in one or more ROM, RAM or PROM chips, field programmable gate arrays (FPGAs) or as an Application Specific Integrated Circuit (ASIC). The software or firmware or other such configurations can be installed onto the computerized device (e.g., during operating system execution or during environment installation) to cause the computerized device to perform the techniques explained herein as embodiments of the invention.

### BRIEF DESCRIPTION OF THE DRAWINGS

The foregoing will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 is a context diagram of a user environment suitable for use with configurations herein;

FIG. 2 is a block diagram of a device locator suitable for use in the environment of FIG. 1;

FIG. 3 is a flowchart of device locating in the device of FIG. 2;

FIG. 4a is an alternate configuration of a stand-alone configuration of the device locator of FIG. 2;

FIG. 4b shows integration of a personal electronic device with the configuration of FIG. 4a;

FIG. 5 is a logic diagram of the device locator as in FIG. 2;

FIG. 6 is an alternate configuration of the device locator of FIG. 2 including external activations; and

FIGS. 7-10 are a flowchart of device locating employing the configuration of FIG. 6.

### DETAILED DESCRIPTION

Depicted below are example configurations of the disclosed approach for locating a lost or misplaced personal electronic device. A variety of arrangements are disclosed, including functionality embedded in the device or cellphone, or integrated into a case, holder or protective enclosure commonly employed with cellphones, smartphones and the like. The disclosed approach may comprise programmed logic in the form of a cellphone or smartphone app (application) for performing the disclosed steps, such as an app downloaded from a public access network. Alternatively, instructions defining the disclosed approach may be initially distributed with a personal electronic device, or upgraded to a deployed device as with a firmware upgrade. The disclosed configurations may interface with native hardware of the device, such as accelerometers, gyroscopes and GPS receivers, or may add location sensing hardware as in the cellphone case integration approach.

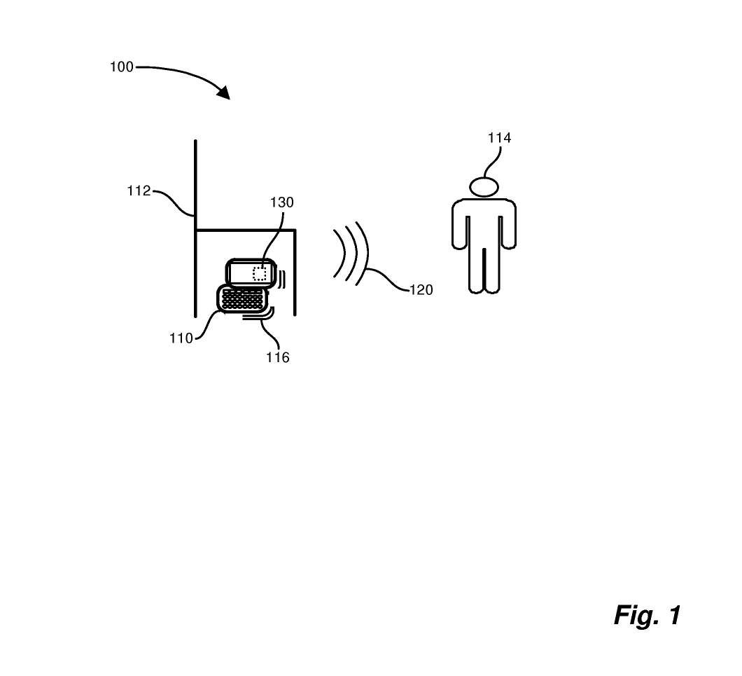

FIG. 1 is a context diagram of a user environment suitable for use with configurations herein. Referring to FIG. 1, in the user environment 100, users 114 employ a personal electronic device 110 (device) such as a cellphone or smartphone for various communication tasks, such as voice conversations, texting, and Internet browsing. Modern technology provides a plethora of options and capabilities in such personal electronic devices 110 under various labels, however, in general such devices perform functions on behalf of an individual user 114 and are sized to be stored in close proximity to the user, such as in a pocket, purse or clip. However, the small size and portability of such devices 110 brings an increased likelihood of being misplaced or lost. For example, the device 110 can easily slip behind or under furniture such as a chair 112 where the device is out of view of the user 114.

One popular remedy to finding a lost cellphone is to call the cellphone so that the cellphone is heard ringing to alert the user to its presence and location. However, when a cellphone has been silenced by disabling the ringer and/or activating “vibrate” mode, the only response may be inaudible vibrations 116. The cellphone remains inaccessible and inaudible until found by the user 114. Further, even if a user elects to attempt to listen for the subtle “buzzing” sound that often accompanies the vibrate alert, such a response would only be detectable until the cellphone battery dies. In contrast, configurations herein provide a method and apparatus for emitting an audible alert 120 independent from volume or ringer settings on the personal electronic device 110 such that the audible alert 120 is unaffected by the silent mode setting. A device finder 130 integrates with the personal electronic device 110 for facilitating the operations discussed below.

In the discussion below, a mute override or silent mode override refers to a control commonly found on cellphone enabled devices to suppress ringer setting and, alternatively, select a “vibrate” mode in which the device vibrates, presumably in a user's pocket, to silently alert the user to an incoming call or text message. A locator activation signal directs the audio rendering device to render an audible signal for locating the device, and may activate the same or different annunciator as the native ringer function. A stationary signal indicates that the logic has concluded that the device has been stationary for predetermined interval, and may therefore be deemed “lost” or misplaced. A misplaced device signal is an external signal requesting a location feedback signal due to an external input such as an incoming call or text message, and not from the stationary signal. The misplaced device signal may be initiated by a user actively concluding that the device has been lost or misplaced. The locator activation signal is triggered by either stationary signal or misplaced device signal for generating an audible alert indicative of the location of the personal electronic device.

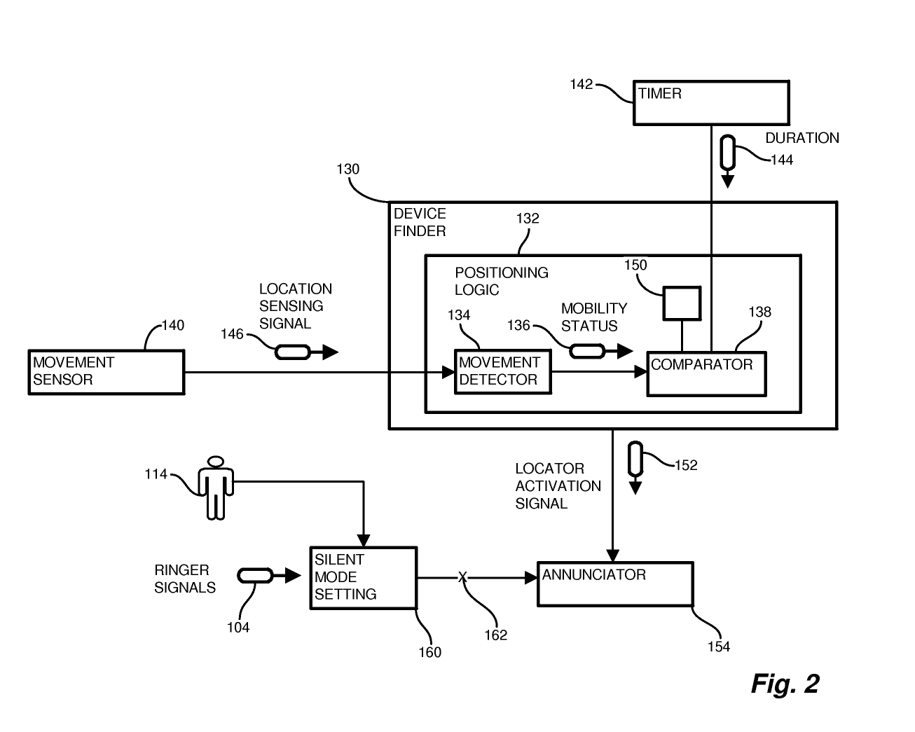

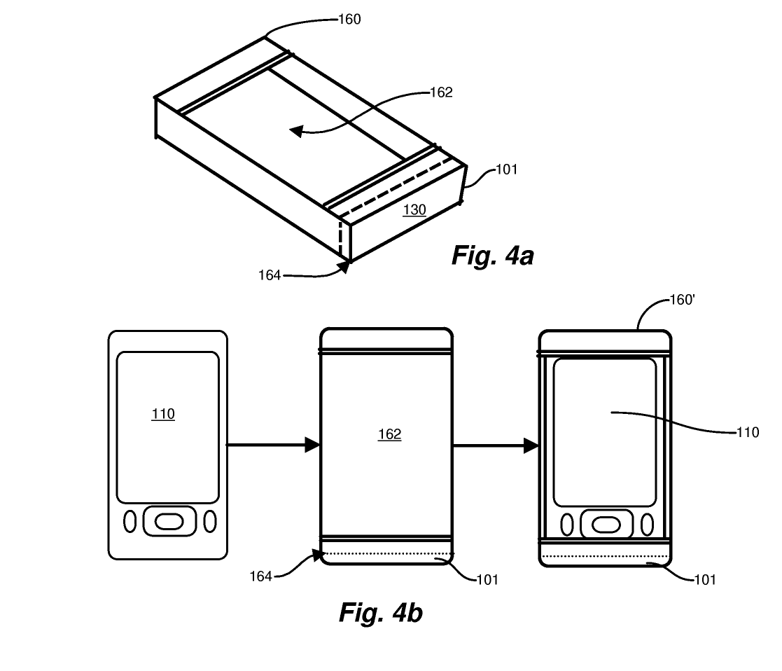

FIG. 2 is a block diagram of a device locator suitable for use in the environment of FIG. 1. Referring to FIGS. 1 and 2, a personal electronic device 110 equipped with a device finder 130 operable for emitting the audible alert 120 of FIG. 1 is shown. The device finder 130, being disposed within the personal electronic device 110 or as a standalone system 101 (FIG. 4a, below), interfaces with a movement sensor 140, such as a gyroscope, accelerometer or GPS receiver (discussed further below) and a timer 142 (i.e. integrated clock). Alternatively, the device finder 140 may include such elements directly. The device finder 130 may operate as an application (“App”) hosted by the device 110, and invokes the native directional hardware (GPS or accelerometer), or as a standalone device having instructions in firmware or other volatile or non-volatile storage medium.

The device finder 130 includes positioning logic 132 for detecting movement of the device 110. The positioning logic 132 includes a movement sensor 134 to identify a stationary device 110 from a location sensing signal 146. Upon determination of a stationary period, the movement detector 134 sends a mobility status 136 to a comparator 138 indicative of a stationary location of the device 110. The comparator 138 identifies a duration of the stationary period by comparing successive locations with a time 144 from the timer 142. A stationary device 110 may be concluded by accelerometer readings of 0, null gyroscopic readings, or duplicate GPS signals. The comparator 138 compares the mobility status signals 136 with the time 144 to compute a stationary duration. If the stationary duration exceeds a predetermined threshold 150 indicative of a lost or misplaced device 110, the device finder 130 sends a locator activation signal 152 to an annunciator 154 of the device 110. The locator activation signal 152 is independent of a silent mode setting 160 set by the user 112 which suppresses 162 other ringer signals 104 generated by the personal electronic device 110 in response to incoming communications or other “ringer” functions.

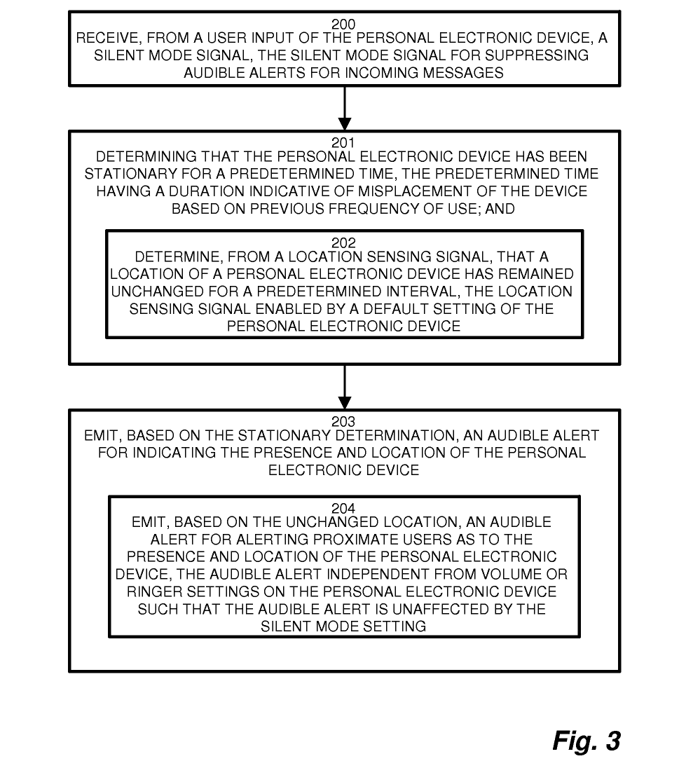

FIG. 3 is a flowchart of device location using the device 110 of FIG. 2. Referring to FIGS. 1-3, at step 200, initially, at some point during usage of the device 110, the device 110 receives, from a user input of the personal electronic device 110, a silent mode setting 160 for suppressing audible alerts 120 for incoming messages. Subsequently, the device finder 130 determines that the personal electronic device 110 has been stationary for a predetermined time, such that the predetermined time has a duration indicative of misplacement of the device based on previous frequency of use, as depicted at step 201. The predetermined time is selected so as not to conclude an ordinary idle period as constituting a “lost” device scenario, nor be so extensive that a user is delayed in locating a truly lost device, draining limited battery life which may be useful in locating the device. Such a determination includes, in the example arrangement, determining, from a location sensing signal, that a location of a personal electronic device 110 has remained unchanged for a predetermined interval, in which the location sensing signal is enabled by a default setting of the personal electronic device to avoid defeating the passive activation, as disclosed at step 202.

The device 110 emits, based on the stationary determination, the audible alert 120 for indicating the presence and location of the personal electronic device 110, as depicted at step 203. This includes, in the example arrangement, emitting, based on the unchanged location, an audible alert 120 for alerting proximate users 114 as to the presence and location of the personal electronic device 110, in which that the audible alert 120 is independent from volume or ringer settings on the personal electronic device such that the audible alert is unaffected by the silent mode setting 160, as disclosed at step 204, and thus bypasses such setting to avoid defeating the purpose of the device finder.

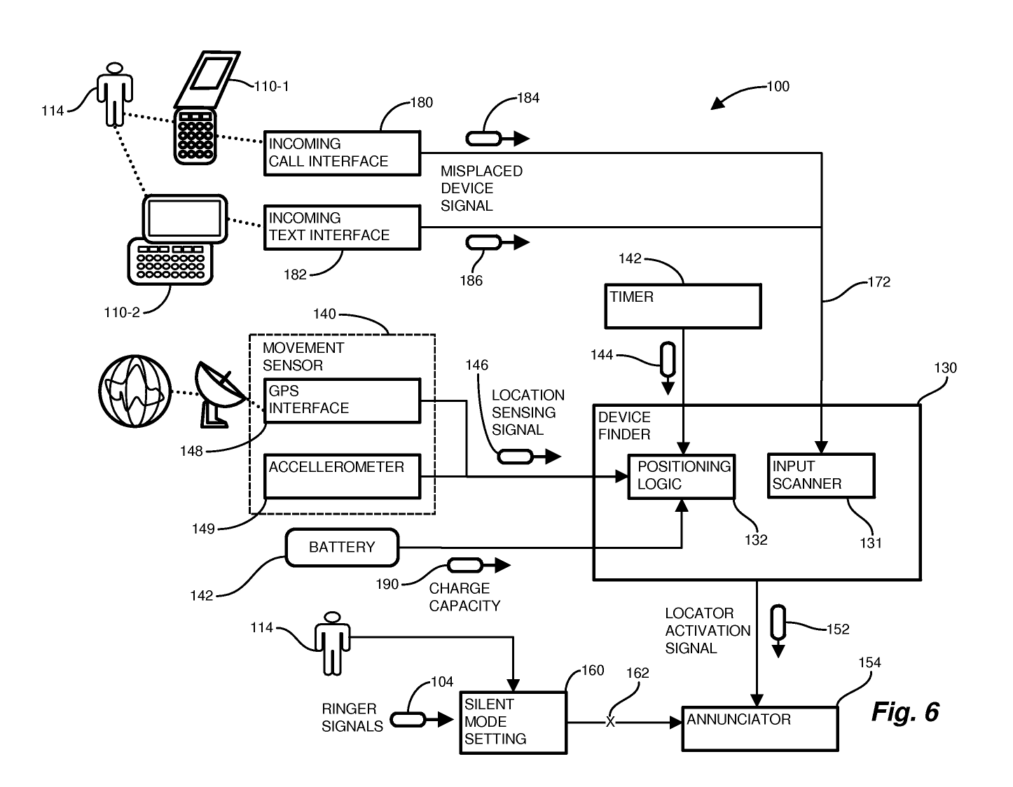

In particular arrangements, several signal paths operate to locate a lost device. Passive determination from the positioning logic 132 and active determination from a user initiated misplaced device signal, discussed below in FIG. 6, may be employed. Additionally, the stationary signal (mobility status 136) may be supplemented when battery power is low, thus raising the possibility that battery power may become exhausted and render the device non-responsive prior to the predetermined time associated with a lost device status. Accordingly, remaining charge capacity in the battery augments the stationary signal to hasten the annunciator alert prior to complete battery discharge.

The locator logic establishes the predetermined interval, or time, indicative of a lost device to be 1.5*the previous 10 stationary periods longer than 1 hour. Alternate parameters may be employed to suit the typical stationary periods of a user 114. Each prolonged stationary period is deemed to be representative of a user idle session, i.e. the length of time the user removes the device from their person or allows it to remain idle, such as overnight. A minimum idle period of 1 hour prunes trivial idle periods, such as sitting in a car or meeting, from skewing the true result of a typical downtime.

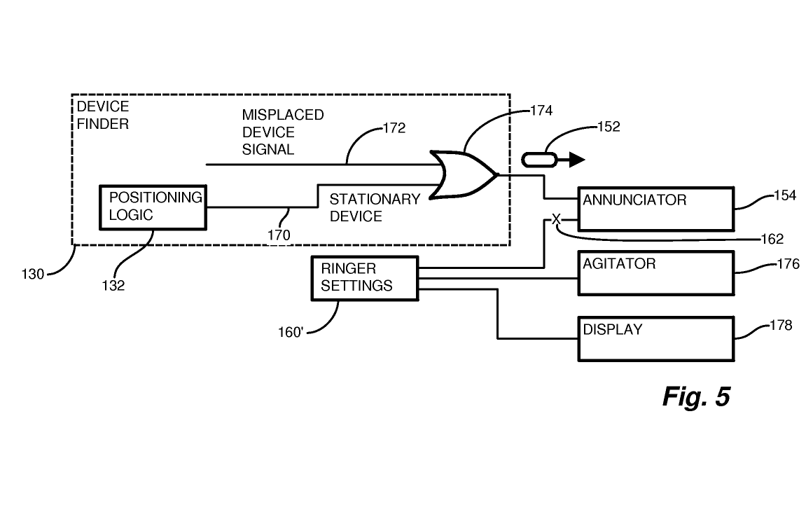

The determination of a stationary device is computed by accumulated signals from the GPS or accelerometer. For the GPS, a series of polled readings remaining unchanged for the predetermined interval establishes motionlessness (i.e. stationary). For the accelerometer, motionlessness is defined as receiving no signal for the predetermined interval. During the predetermined interval of motionlessness, a revised percentage of the predetermined interval deemed to indicate a stationery device is computed by reducing the outstanding motionlessness period based on the remaining battery life (charge capacity). The balance for the remaining predetermined interval is computed from by the predetermined interval−the elapsed predetermined interval)/predetermined interval, so if the predetermined interval is 10 hours, and 6 hours have elapsed, then the balance is ((10−6)/10)=0.4, or 40%. The low battery augments this to trigger the stationary device signal sooner as battery power degrades. The low battery determination is the ratio of the balance of the remaining predetermined interval to remaining battery capacity, based on the remaining battery charge capacity percentage to the remaining predetermined interval, such as by a charge augmentation factor of 2. For example, using a factor of 2, indicates that when the battery capacity 190 is less than ½ the predetermined duration remaining (unelapsed), the stationary device signal 170 (FIG. 5 below), based on mobility status 136 of motionless, activates. Thus, in this example, the low battery signal triggers when the remaining capacity<(remaining predetermined interval/2), such that the low battery would trigger when the charge capacity is less than 20%/2, or 10% of the charge capacity. An augmentation factor of 4 would allow the battery to dip to 20%/4, or 5% capacity, before flagging an alert, while an augmentation factor of 1 would trigger the stationary signal at 20%. An absolute value, such as 3 or 5% of battery capacity, may also be employed to guard against an overly aggressive augmentation factor. An absolute charge capacity threshold may also be set, such as 5% of battery capacity, regardless of the unelapsed motionless period. Other values may be employed for the charge augmentation to allow more or less battery drain before cutting the predetermined interval short to issue the stationary device signal.

In mathematical terms, for example, the positioning logic might establish the following:

Set predetermined interval to be 1.5*previous 10 stationary periods longer than 1 hour (i.e. overnight), to avoid mitigating a meaningful motionlessness period with trivial “at rest” periods;

Stationary motion status=(no accelerometer signal or GPS polled location unchanged) for predetermined interval;

Balance of remaining predetermined interval=(predetermined interval−elapsed predetermined interval)/predetermined interval;

Low battery=remaining capacity<(balance of remaining predetermined interval until stationary/augmentation factor) or 0.1 of battery capacity;

Other and/or alternate parameters may be apparent.

FIG. 4a is an alternate configuration of a stand-alone configuration, and FIG. 4b shows integration of a personal electronic device 110 with the configuration of FIG. 4a. In FIG. 4a, the device finder 130 is deployed as a standalone configuration 101, which incorporates functions other wise provided by the personal electronic device 110. The standalone configuration 101, therefore, simply includes the movement sensor, timer and annunciator rather than sharing or incorporating the onboard features of the device 110.

The standalone configuration 101 may be deployed in a case 160 having a cavity 162 or recess for containing the personal electronic device 110. Personal electronic devices 110 are often deployed in such method for finding a misplaced personal electronic device a case 160 for protective or aesthetic reasons; the standalone configuration 101 is disposed at an end 164 or elsewhere in or on the case 160, and therefore allows operation with any device by merely insertion in the cavity 162.

FIG. 4b shows installation of a device 110 with the standalone configuration 101. A user 114 inserts the personal electronic device 110 into the cavity 162 of the case 160. The case 160 includes the standalone configuration 101 integrated at the end 164 of the case. The result is an installed device 110 in the case 160′ with the standalone configuration 101.

FIG. 5 is a logic diagram of the device locator as in FIG. 2. Referring to FIGS. 2 and 5, the device finder 130 activates the annunciator 154 upon either a stationary device signal 170 computed by the positioning logic 132 or an explicit misplaced device signal 172, discussed further below, either of which initiates the location activator signal 152, as determined by OR gate 174.

The annunciator 154 activates on either the locator activation signal 152 or a ringer setting 160′, however the ringer setting 160′ can be set to suppress 162 the annunciator 154 and activate only the agitator (in a vibrate ringer setting) 176 or visual display 178 during normal operation of the personal electronic device 110, therefore the locator activation signal 152 independently activates the annunciator 154.

FIG. 6 is an alternate configuration of the device locator of FIG. 2 showing more detail and including external activations. Referring to FIGS. 2, 5 and 6, the device finder 130 also connects to an incoming call interface 180 and an incoming text interface 182 for providing the explicit misplaced device signal 172. The misplaced device signal 172 may be undertaken by a proactive user 114 who determines that the personal electronic device 110 may be missing and desires to invoke the device finder 130 to bypass 162 a previously set silent mode setting.

For voice device 110-1 operation, the incoming call interface 180 receives a call to a particular number, typically the phone number of the device 110-1 but also may be activated via a third party who then calls back the device 110-1, similar to a voice mail retrieval from a central server. During the ringback period, the user presses a particular key or key sequence to indicate to the device 110-1 that a voice based misplaced device signal message 184 is to be generated. For text enabled devices 110-2, the incoming text interface 182 receives a predetermined text string, such as “LOSTDEVICE” or other suitable string, as a text based misplaced device signal 186. In either case, an input scanner 131 identifies the misplaced device signal 172 and activates the locator activation signal 152.

The movement sensor 140 may include either a GPS interface 148 or an accelerometer 149 for concluding that the device has not moved and is therefore determined to be misplaced or lost. The GPS interface 148 sends periodic location sensing signals 146 to the positioning logic 132, and if an unchanged location is indicated for the duration of a predetermined time (by comparison with the time 144 from the timer), then the positioning logic generates the locator activation signal 152. The predetermined time may represent an overnight period, such as 8 or 12 hours, in anticipation of a device 110 remaining idle overnight, or may be longer, such as 24-48 hours in the case of a less frequent user.

The accelerometer 149, also common in many personal electronic devices 110, may also send location sensing signals 146. The accelerometer 149 senses relative movement (rather than absolute location as with the GPS interface 148), and therefore senses when the device 110 is picked up or carried, such as in a handbag or pocket of the user 114. The positioning logic 132 interprets absence of such movement for the predetermined period as an indication of a lost device and sends the locator activation signal 152 accordingly.

The predetermined period of motionlessness deemed to constitute a lost device, and trigger the locator activation signal 152, may be supplemented or superceded by a charge capacity signal 190 from a battery 142 of the device 110. If the battery 142 is running down, the positioning logic 132 receives the charge capacity signal 190 to indicate that the power required to initiate the locator activation signal 152 needs to be expedited before the battery power is insufficient to generate such a signal. Accordingly, the charge capacity 190 may reduce the predetermined period deemed to constitute a lost device, such as halving the period when only 25% of the battery power is remaining, or by simply issuing a locator activation signal 152 when the battery reaches a percentage of remaining power, such as 10%.

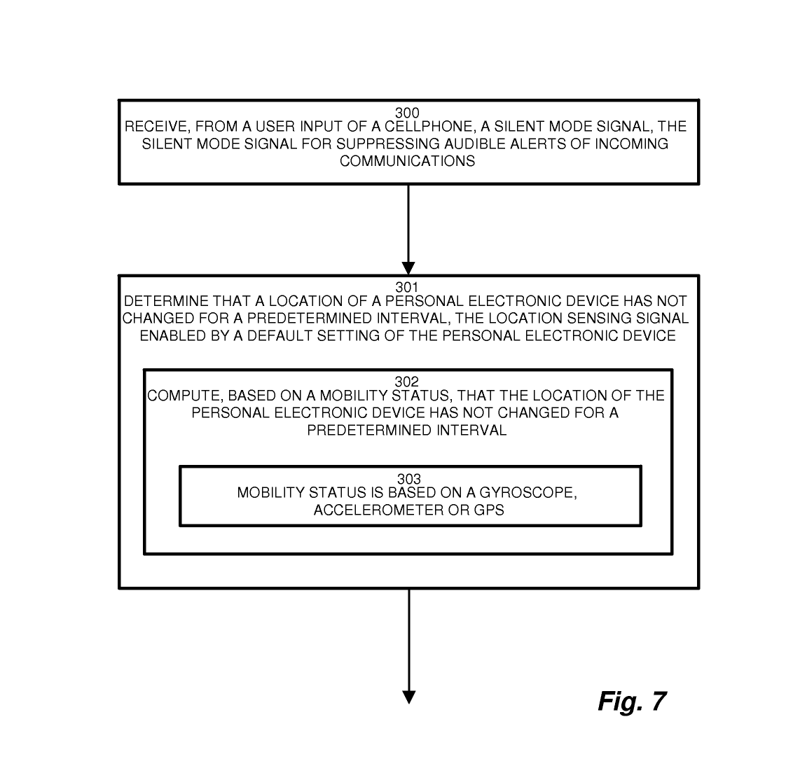

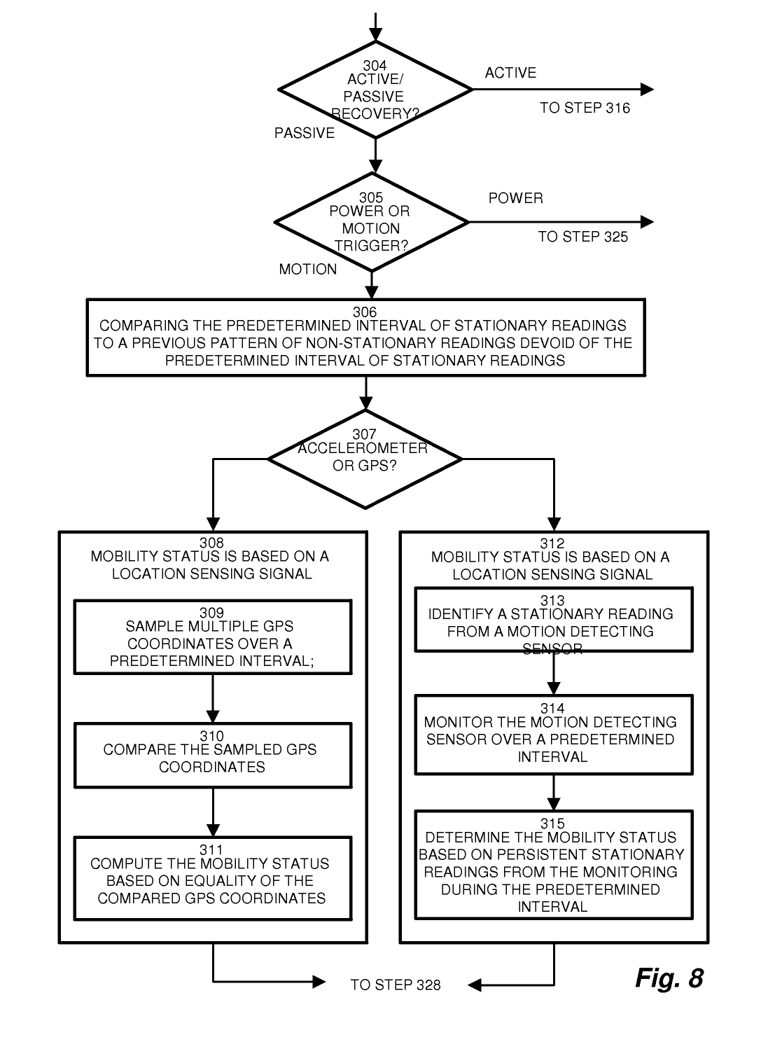

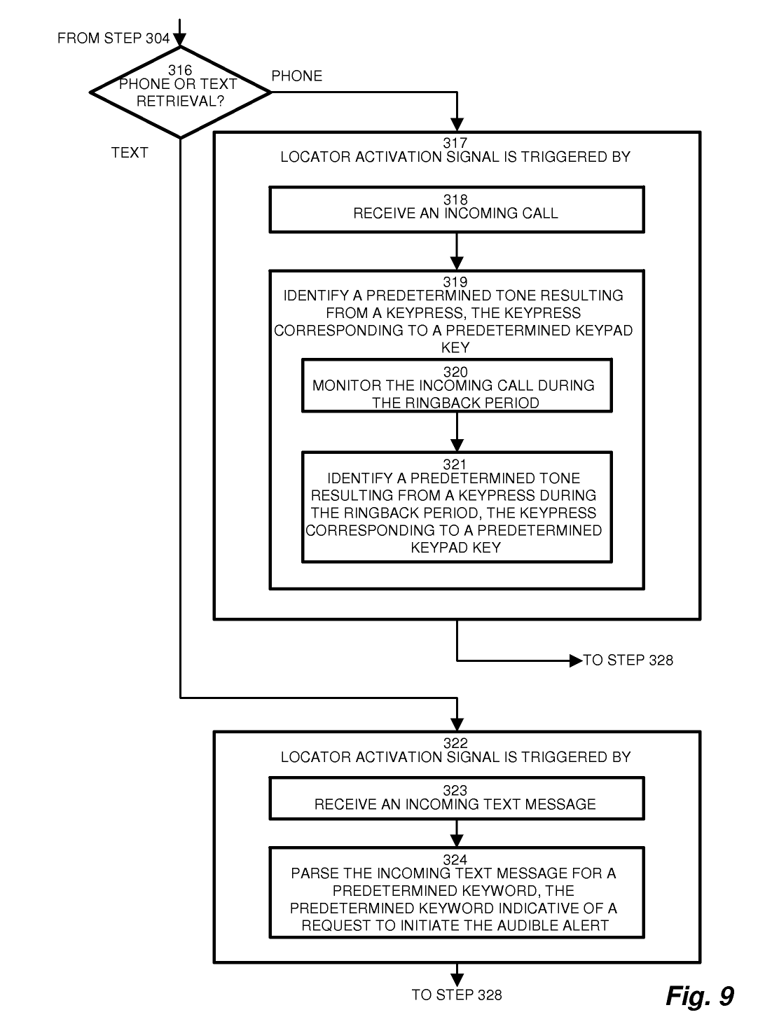

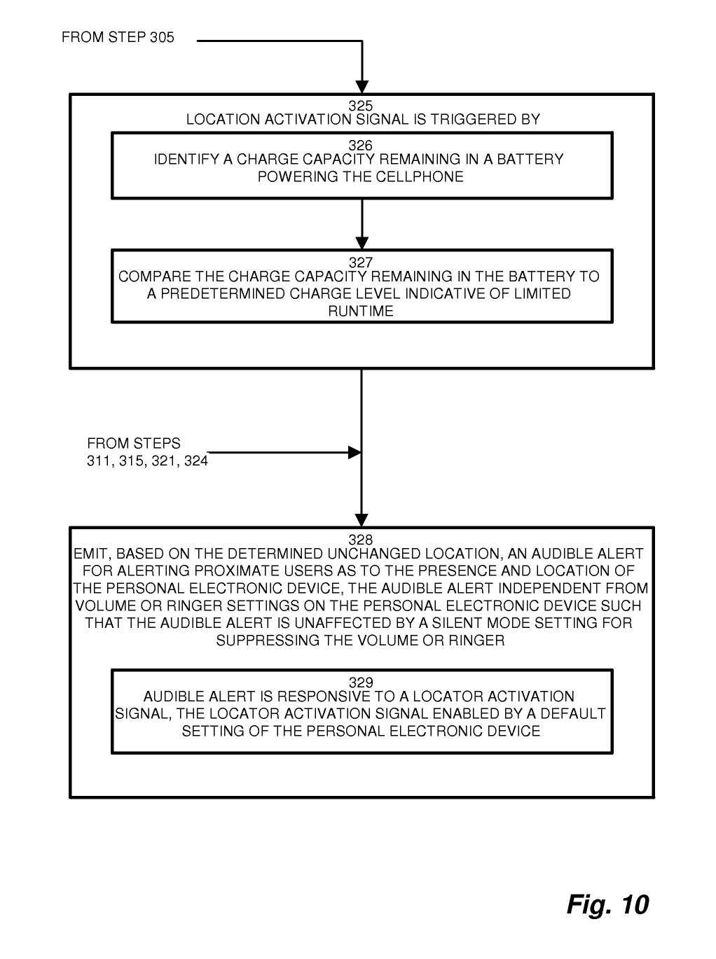

FIGS. 7-10 are a flowchart of device locating employing the configuration of FIG. 6. Referring to FIGS. 2 and 6-10, the method for finding a misplaced personal electronic device includes receiving, from a user 114 of the cellphone (or other device 110), a silent mode setting 160, in which the silent mode setting 160 is for suppressing 162 audible alerts (ringer signals) 104 of incoming communications, as depicted at step 300. The device finder 130 initiates the determination that a location of a personal electronic device 110 has not changed for a predetermined interval, in which the location sensing signal 146 enabled by a default setting of the personal electronic device, as shown at step 301. The device finder 130 will compute, based on a mobility status 136, that the location of the personal electronic device 110 has not changed for a predetermined interval, as depicted at step 302, such that the mobility status is based on a gyroscope, accelerometer 149 or GPS 148, as shown at step 303.

A check is performed, at step 304, for active or passive recovery. Passive recovery results from user inactivity, as when the device 110 remains motionless (location sensing signal) 146 or the battery becomes depleted (charge capacity 190). Active recovery results from a misplaced device signal 184, 186 from an incoming call 180 or text 182 interface.

For passive recovery, a check at step 305 examines battery power or motion based triggers. In the case of motion based triggers, then the positioning logic 132 determines mobility status by first comparing the predetermined interval of stationary readings to a previous pattern of non-stationary readings devoid of the predetermined interval of stationary readings to identify a typical idle time for the device 110, as depicted at step 306. In other words, the predetermined interval representative of a “normal” idle, or at rest period looks to a duration of time for which the device 110 is not at rest, meaning that it is disturbed (experiences movement) some time prior to the expiration of the predetermined interval of rest expiring. For example, consider a typical cellphone (device 110) may remain motionless, and “at rest,” for about 6-8 hours overnight. Often, however, a device 110 will remain at rest on a desk, or in a pocket, for several hours during which the user is engaged with other activities. Such at rest periods will be shorter than an extended “normal” idle period such as overnight (about 6-8 hours). Therefore, the shorter at rest periods are not representative of a longest typical at rest period (i.e. overnight), and should not be employed to determine excessive idle time. Only an idle period in excess of the longest “typical” rest period (i.e. substantially longer than a 6-8 hour overnight) should constitute an excessive predetermined interval sufficient to trigger passive recovery.

Having established the predetermined interval, then, depending on available motion sensing input, a check at step 307 identifies whether accelerometer or GPS input is available. If GPS readings 148 are available, then the mobility status is based on the location sensing signal 146, as shown at step 308. The GPS based signal is computed by sampling multiple GPS coordinates over a predetermined interval, as depicted at step 309, comparing the sampled GPS coordinates, as shown at step 310, and computing the mobility status 136 based on equality of the compared GPS coordinates, as depicted at step 311. Therefore, a sequence of similar GPS readings indicates that the device 110 has not moved. Such readings would typically be taken periodically in a polling manner, to establish persistent stationary readings from the same location.

If accelerometer 149 capability is available, then at step 312 the mobility status is based on a location sensing signal computed by identifying a stationary reading from a motion detecting sensor such as an accelerometer or similar component, depicted at step 313, and monitoring the motion detecting sensor over a predetermined interval as shown at step 314. The positioning logic 132 then determines the mobility status 136 based on persistent stationary readings from the monitoring during the predetermined interval, as depicted at step 315.

Alternatively, if power based triggering is invoked at step 305, then at step 325 the locator activation signal 152 is triggered by identifying a charge capacity 190 remaining in a battery powering the cellphone, as depicted at step 326, and comparing the charge capacity remaining in the battery to a predetermined charge level indicative of limited runtime, as shown at step 327. As indicated above, an augmentation factor may be employed to indicate of a ratio of remaining charge to an unelapsed predetermined interval remaining in the current stationary period The device finder 130 computes a critical battery percentage based on the unelapsed predetermined interval/the augmentation factor, and triggers the location activator signal 152 when the percentage of charge capacity remaining is less than the critical battery percentage.

Returning to step 304, in the case of active recovery, the locator activation signal may be triggered by a proactive user who discovers that their device 110 is missing. Based on the check at step 316, a phone (voice) or text activation is selected. In the case of phone activation, at step 317 the locator activation signal 152 is initiated by receiving, by the device 110, an incoming call, as depicted at step 318, and identifying a predetermined tone resulting from a keypress, in which the keypress corresponds to a predetermined keypad key, as shown at step 319. The input scanner 131 monitors the incoming call interface 180 during the ringback period for a misplaced device signal 184, as shown at step 320. The input scanner 131 identifies a predetermined tone resulting from a keypress during the ringback period, such that the keypress corresponds to a predetermined keypad key (e.g. “*” or “#”, for example), as disclosed at step 321.

Alternatively, the incoming text interface 182 is invoked at step 316, and at step 322 the locator activation signal 152 is triggered by receiving an incoming text message 186, as depicted at step 323, and the input scanner 131 parses the incoming text message 186 for a predetermined keyword, such that the predetermined keyword is indicative of a request to initiate the audible alert, as shown at step 324. Therefore, a user 114 may define a word such as “FIND” or “LOST” as the match to the misplaced device signal 186 that, when sent to the personal electronic device 110, initiates the locator activation signal 152.

From any of steps 311, 315, 321 or 324, the annunciator 154 emits, based on the determined unchanged location, the audible alert 120 for alerting proximate users as to the presence and location of the personal electronic device 110, such that the audible alert is independent from volume or ringer settings on the personal electronic device and is thus the audible alert 120 is unaffected by the silent mode setting 160 for suppressing the volume or ringer, as depicted at step 328. Further, in particular configurations, the audible alert 120 is responsive to the locator activation signal 152, such that the locator activation signal is enabled by a default setting of the personal electronic device 110 for avoiding user self-defeating of the audible alert 120, as shown at step 329.

It will be appreciated by those skilled in the art that alternate configurations of the disclosed invention include a multiprogramming or multiprocessing computerized device such as a workstation, handheld or laptop computer or dedicated computing device or the like configured with software and/or circuitry (e.g., a processor as summarized above) to process any or all of the method operations disclosed herein as embodiments of the invention. Still other embodiments of the invention include software programs such as a Java Virtual Machine and/or an operating system that can operate alone or in conjunction with each other with a multiprocessing computerized device to perform the method embodiment steps and operations summarized above and disclosed in detail below. One such embodiment comprises a computer program product that has a computer-readable storage medium including computer program logic encoded thereon that, when performed in a multiprocessing computerized device having a coupling of a memory and a processor, programs the processor to perform the operations disclosed herein as embodiments of the invention to carry out data access requests. Such arrangements of the invention are typically provided as software, code and/or other data (e.g., data structures) arranged or encoded on a non-transitory computer readable storage medium such as an optical medium (e.g., CD-ROM), floppy or hard disk or other medium such as firmware or microcode in one or more ROM, RAM or PROM chips, field programmable gate arrays (FPGAs) or as an Application Specific Integrated Circuit (ASIC). The software or firmware or other such configurations can be installed onto the computerized device (e.g., during operating system execution or during environment installation) to cause the computerized device to perform the techniques explained herein as embodiments of the invention.

What is claimed is:

1. A computer program product stored on a non-transitory computer readable storage medium for performing a method for finding a misplaced personal electronic device comprising:
receiving, from a user input of the personal electronic device, a silent mode signal, the silent mode signal for suppressing audible notifications of incoming messages;
determining that a location of the personal electronic device has remained unchanged for a predetermined interval; and
emitting, based on the unchanged location, an audible alert for alerting proximate users as to the presence and location of the personal electronic device, the audible alert independent from volume or ringer settings on the personal electronic device such that the audible alert is unaffected by the silent mode signal.

2. The method of claim 1 wherein the audible alert is responsive to a locator activation signal, the locator activation signal enabled by a default setting of the personal electronic device.

3. The method of claim 2 further comprising receiving, from a user input of the personal electronic device, a silent mode setting, the silent mode setting establishing a silent mode setting for suppressing audible notifications of incoming communications.

4. The method of claim 2 further comprising computing a mobility status indicating that the location of the personal electronic device has not changed for a predetermined interval.

5. The method of claim 4 wherein the computed mobility status is based on a gyroscope, accelerometer or GPS coordinate input.

6. The method of claim 4 wherein the mobility status is based on a location sensing signal, the location sensing signal computed by:
sampling multiple GPS coordinates over a predetermined interval;
comparing the sampled GPS coordinates; and
computing the mobility status based on equality of the compared GPS coordinates.

7. The method of claim 4 wherein the mobility status is based on a location sensing signal, the location sensing signal computed by:
identifying a stationary reading from a motion detecting sensor;
monitoring the motion detecting sensor over a predetermined interval; and
determining the mobility status based on persistent stationary readings from the monitoring during the predetermined interval.

8. The method of claim 7 wherein determining mobility status further comprises comparing the predetermined interval of stationary readings to a previous pattern of non-stationary readings devoid of the predetermined interval of stationary readings.

9. The method of claim 2 wherein the locator activation signal is triggered by:
identifying a charge capacity remaining in a battery powering the cellphone; and
comparing the charge capacity remaining in the battery to a predetermined charge level indicative of limited runtime.

10. The method of claim 2 further wherein the locator activation signal is triggered by:
identifying a charge capacity remaining of the a battery powering the cellphone, and
comparing the identified charge capacity based on a ratio of remaining charge to a remaining predetermined interval.

11. The method of claim 2 further comprising
determining an augmentation factor indicative of a ratio of remaining charge to an unelapsed predetermined interval remaining in the current stationary period;
computing a critical battery percentage based on the unelapsed predetermined interval/the augmentation factor; and
triggering a location activator signal when the percentage of charge capacity remaining is less than the critical battery percentage.

12. In a wireless device environment, the environment supporting a plurality of personal electronic devices, a method for locating a lost personal electronic device comprising:
receiving, from a user input of the personal electronic device, a silent mode setting, the silent mode setting for suppressing audible notifications for incoming messages; and
emitting, based on a locator activation signal, an audible alert for alerting proximate users as to the presence and location of the personal electronic device, the audible alert independent from volume or ringer settings on the personal electronic device such that the audible alert is unaffected by the silent mode setting.

13. The method of claim 12 further comprising:
determining, from a location sensing signal, that a location of the personal electronic device has remained stationary for a predetermined interval, the predetermined interval having a duration indicative of misplacement of the device based on previous frequency of use; and
generating, based on the stationary determination, the locator activation signal for emitting, the audible alert.

14. The method of claim 12 wherein the locator activation signal is triggered by:
receiving an incoming call; and
identifying a predetermined tone resulting from a keypress, the keypress corresponding to a predetermined keypad key.

15. The method of claim 12 wherein the locator activation signal is triggered by
receiving an incoming call;
monitoring the incoming call during the ringback period; and
identifying a predetermined tone resulting from a keypress during the ringback period, the keypress corresponding to a predetermined keypad key.

16. The method of claim 12 wherein the locator activation signal is triggered by:
receiving an incoming text message;
parsing the incoming text message for a predetermined keyword, the predetermined keyword indicative of a request to initiate the audible alert.

17. A locator device for locating a personal electronic device that has not been utilized for a predetermined time comprising:
a movement sensor configured to generate a location sensing signal for determining that the personal electronic device has been stationary for the predetermined time, the predetermined time having a duration indicative of misplacement of the device based on previous frequency of use; and
an annunciator responsive to the location sensing signal for emitting an audible alert for indicating the presence and location of the personal electronic device.

18. The device of claim 17 wherein the audible alert is independent from volume or ringer settings on the personal electronic device such that the audible alert is unaffected by a silent mode setting, further comprising:
rendering the audible alert via an annunciator on the personal electronic device regardless of the silent mode setting.

19. The device of claim 17 wherein the location sensing signal is based on at least one of a gyroscope, accelerometer or GPS sensing indicating that the location of the cellphone has not changed.

20. The device of claim 17 wherein the personal electronic device is integrated with an enclosure adapted for nonintrusive engagement with the personal electronic device such that the enclosure permits unobstructed access to keys and ports on the personal electronic device, the enclosure containing the personal electronic device for preventing accidental disengagement.
